(19) United States
(12) Patent Application Publication
(10) Pub. No.: US 2016/0168437 A1
(43) Pub. Date: Jun. 16, 2016

(54) PROPELLANT ISOLATION BARRIER

(71) Applicant: Busek Co., Inc., Natick, MA (US)

(72) Inventors: Nathaniel Demmons, Mason, NH (US); Vladimir J. Hruby, Waban, MA (US); Douglas Spence, Seattle, WA (US)

(73) Assignee: Busek Co., Inc.

(21) Appl. No.: 14/548,998

(22) Filed: Nov. 20, 2014

Related U.S. Application Data
(60) Provisional application No. 61/977,202, filed on Apr. 9, 2014.

(51) Int. Cl. C09K 3/30

(52) U.S. Cl. CPC C09K 3/30

(57) ABSTRACT

A propellant isolation barrier including an ionic liquid is configured to have a solid phase at temperatures less than a predetermined temperature and a liquid phase at temperatures greater than the predetermined temperature. The ionic liquid is configured to create a propellant isolation barrier in the solid phase, mix with a primary liquid propellant in the liquid phase, and remain in the liquid phase and miscible with the primary liquid propellant at temperatures greater than and less than the predetermined temperature when mixed with the primary propellant.

### RELATED APPLICATIONS

This application claims benefit of and priority to U.S. Provisional Application Ser. No. 61/977,202, filed on Apr. 9, 2014 under 35 U.S.C. §§119, 120, 363, 365, and 37 C.F.R. §1.55 and §1.78 incorporated herein by this reference.

### GOVERNMENT RIGHTS

This invention was made with U.S. Government support under Contract No. NNX08CD10P and NNX09CA81C issued by National Aeronautics and Space Administration (NASA), Air Force Contract Nos. FA9300-12-M-1004 and FA9300-13-C-2009. The Government may have certain rights herein.

### FIELD OF THE INVENTION

This invention relates to a propellant isolation barrier.

### BACKGROUND OF THE INVENTION

Electrospray thrusters can operate by generating and expelling charged droplets or ions from a conductive liquid that are accelerated through an electrostatic field. Electrospray thrusters typically use ionic liquids as a propellant. Ionic liquids are ideal in that they have negligible vapor pressure and do not evaporate when exposed to high vacuum conditions. However, conventional ionic liquids used as propellant in electrospray thrusters can absorb contaminants at atmospheric conditions, such as water vapor, atmospheric gases, particles, and the like, that can detrimentally affect the performance of the electrospray thruster. Thus, electrospray thrusters require propellant isolation systems at atmospheric conditions, such as valves or other similar type devices, to protect the ionic liquid propellant in the propellant storage vessel. Such propellant isolation systems can fail and increase expense.

### BRIEF SUMMARY OF THE INVENTION

In one aspect, a propellant isolation barrier is featured including an ionic liquid configured to have a solid phase at temperatures less than a predetermined temperature and a liquid phase at temperatures greater than the predetermined temperature. The ionic liquid is configured to create a propellant isolation barrier in the solid phase, mix with a primary liquid propellant in the liquid phase, and remain in the liquid phase and miscible with the primary liquid propellant at temperatures greater than and less than the predetermined temperature when mixed with the primary propellant.

In one embodiment, the ionic liquid may include a hydrophobic ionic liquid having a melting temperature greater than the melting temperature of the primary propellant. The ionic liquid may include one or more of: 1-ethyl-3-methylimidazolium hexafluorophosphate (EMI PF6), 1-methyl-3-(3,3, . . . -tridecafluoroctyl)imidazolium hexafluophosphate, and Tetrabutyl-ammonium bis(trifluoromethylsulfonyl)imide. The ionic liquid in the liquid phase may be configured as a secondary liquid propellant. The propellant isolation barrier may be between the primary liquid propellant and the atmosphere. The propellant isolation barrier may prevent absorption of one or more of water vapor, atmospheric gases, and/or particles by the primary liquid propellant at atmospheric conditions. The propellant isolation barrier may prevent wetting of an emitter and a propellant delivery pathway of a wicking based feed subsystem of an electrospray thruster by the primary liquid propellant to ensure proper filling of a propellant storage vessel under the operation environment of the electrospray thruster system. The propellant isolation barrier may be valveless. The primary liquid propellant may include an ionic liquid having electrical conductivity, viscosity and surface tension suitable for operation with an electrospray thruster. The primary liquid propellant may include one or more of: 1-ethyl-3-methylimidazolium bis(trifluoromethylsulfonyl)imide (EMI-Im), 1-ethyl-3-methylimidazolium tetrafluoroborate, (EMI-BF4), 1-butyl-3-methylimidazolium hexafluorophosphate ([bmim][PF(6)]), and 1-Ethyl-3-methylimidazolium thiocyanate.

In another aspect, a propellant isolation barrier for an electrospray device is featured including an ionic liquid configured to have a solid phase at temperatures less than a predetermined temperature and a liquid phase at temperatures greater than the predetermined temperature. The ionic liquid is configured to create a propellant isolation barrier in the solid phase, mix with a primary liquid propellant in the liquid phase, and remain in the liquid phase and miscible with the primary liquid propellant at temperatures greater than and less than the predetermined temperature when mixed with the primary propellant.

In one embodiment, the ionic liquid may include a hydrophobic ionic liquid having a melting temperature greater than the melting temperature of the primary propellant. The ionic liquid may include one or more of: 1-ethyl-3-methylimidazolium hexafluorophosphate (EMI PF6), 1-methyl-3-(3,3, . . . -tridecafluoroctyl)imidazolium hexafluophosphate, and tetrabutyl-ammonium bis(trifluoromethylsulfonyl)imide. The ionic liquid in the liquid phase may be configured as a secondary liquid propellant. The propellant isolation barrier may be between the primary liquid propellant and the atmosphere. The propellant isolation barrier may prevent absorption of one or more of water vapor, atmospheric gases, and/or particles by the primary liquid propellant at atmospheric conditions. The propellant isolation barrier may prevent wetting of an emitter and a propellant delivery pathway of a wicking based feed subsystem of an electrospray thruster by the primary liquid propellant to ensure proper filling of a propellant storage vessel under the operation environment of the electrospray thruster system. The propellant isolation barrier may be valveless. The primary liquid propellant may include one or more of: 1-ethyl-3-methylimidazolium bis(triflouromethylsulfonyl)amide, (EMI-Im), 1-ethyl-3-methylimidazolium tetrafluoroborate (EMI-BF4), 1-butyl-3-methylimidazolium hexafluorophosphate ([bmim][PF(6)]) and 1-ethyl-3-methylimidazolium thiocyanate.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view showing one embodiment of the propellant isolation barrier of this invention; and

FIG. 2 is a schematic view showing the isolation barrier shown in FIG. 1 in the liquid phase and mixed with the primary propellant.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

As discussed in the Background section above, electrospray thrusters often use ionic liquids as a propellant because they have negligible vapor pressure and do not evaporate when exposed to vacuum conditions. Some conventional ionic liquid propellants use by electrospray thrusters include 1-ethyl-3-methylimidazolium bis(trifluoromethylsulfonyl)imide (EMI-Im), 1-ethyl-3-methylimidazoliurn tetrafluoroborate, (EMI-BF4), 1-butyl-3-methylimidazolium hexafluorophosphate ([bmim][PF(6)]), 1-ethyl-3-methylimidazolium thiocyanate, and the like, However, when conventional ionic liquids are used as propellant in electrospray thrusters, they can absorb contaminants at atmospheric conditions which can detrimentally affect the performance of the electrode spray thruster. Thus, electrospray thrusters rely on cumbersome propellant isolation systems, such as valves and the like, to protect the ionic liquid propellant in the storage vessel. Such propellant isolation systems can fail and incur additional expense.

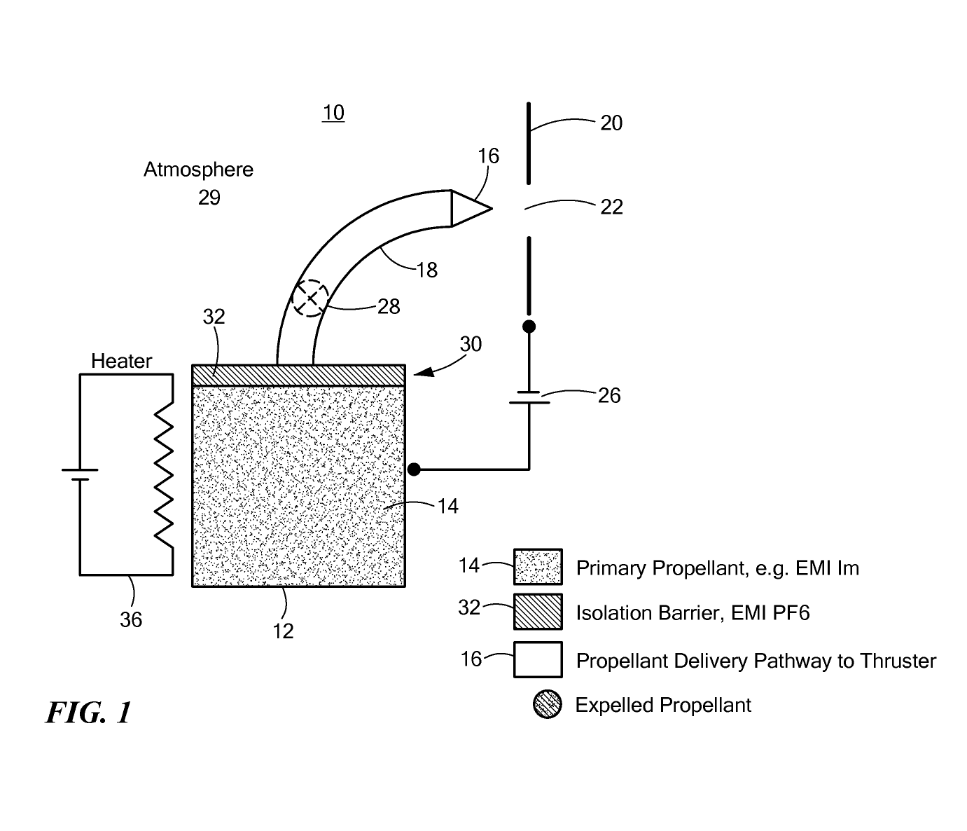

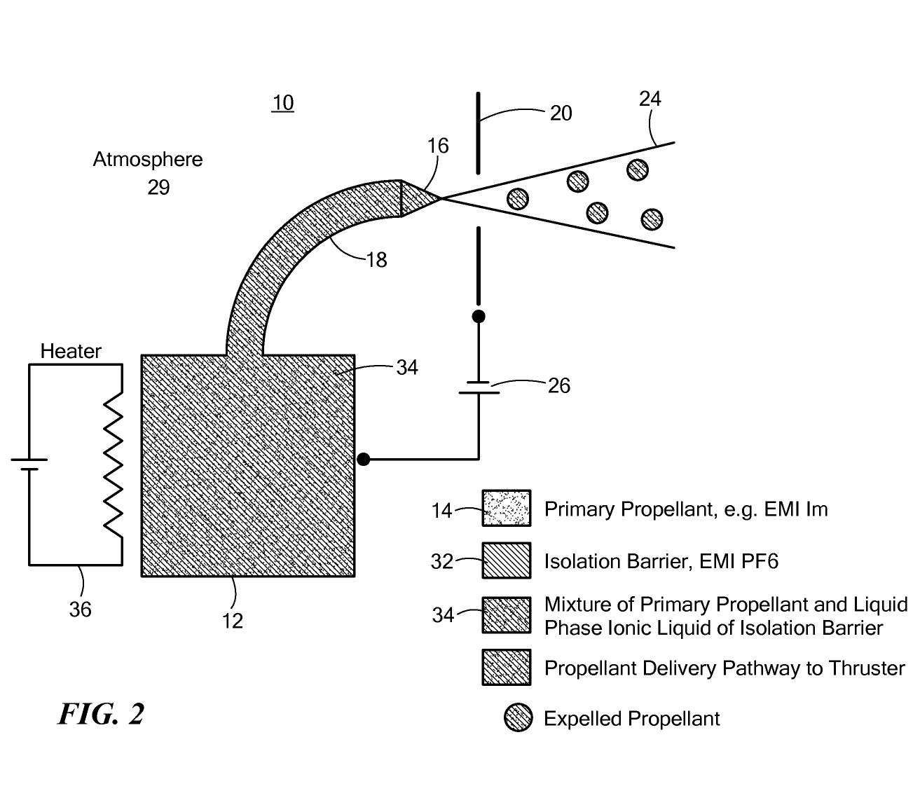

There is shown in FIG. 1 a typical electrospray thruster 10 that includes storage vessel 12 which stores primary conventional ionic liquid propellant 14 as discussed above. Electrospray thruster 10 also includes emitter 16 coupled to propellant delivery pathway 18 which is adapted to receive propellant 14. Electrospray thruster 10 also includes extraction grid 20 with aperture 22 through which electrospray 24, FIG. 2, is formed and expelled. Power supply 26, FIG. 1, e.g., a battery or similar type power supply, is connected across extraction plate 20 and storage vessel 12 to create a voltage potential difference to create electrospray 24 to create thrust.

Electrospray thruster 10 typically relies on some type of propellant isolation system, e.g., propellant isolation system 28 (shown in phantom), such as a value or similar type device, to protect ionic liquid propellant 14 from absorbing contaminants from atmosphere 29.

Propellant isolation barrier 30 of one embodiment of this invention includes ionic liquid 32 configured to have a solid phase at temperatures less than a predetermined temperature, e.g., about 60° C., and a liquid phase at temperatures greater than the predetermined temperature, e.g., 60° C. Ionic liquid 32 is configured to create propellant isolation barrier 30, FIG. 1, when in the solid phase (as shown) at atmospheric conditions and mix with primary propellant 14, as shown by mixture 34, FIG. 2, where like parts have been given like numbers, in the liquid phase, and remain in the liquid phase and miscible with primary liquid propellant 14 at the temperatures greater or less than the predetermined temperature when mixed with primary propellant 14 to create electrospray 20 to create thrust. Thus, after ionic liquid 32, FIG. 1, in the solid form has melted mixed with primary propellant 14 as shown by mixture 34, FIG. 2, ionic liquid 32 remains in the liquid phase over the operating temperature of primary propellant 14 of electrospray thruster, e.g., about 20° C.

In one design, heater 36 may be used to heat ionic liquid 32 of propellant isolation barrier 30 to change it from the solid phase as shown in FIG. 1 to the liquid phase as shown in FIG. 2.

The result is isolation barrier 30, FIG. 1, prevents the absorption of water vapor, atmospheric gases, particles, and the like, by primary propellant 14 from atmosphere 29 at atmospheric conditions without requiring propellant isolation subsystem, e.g., propellant isolation subsystem. Isolation barrier 30 also prevents wetting of the wicking based feed subsystem of electrospray thruster 10 comprised of emitter 16 and propellant delivery pathway 18 by primary liquid propellant to ensure proper filling of a propellant storage vessel 12 under the operation environment of the electrospray thruster, e.g., vacuum condition of outer space. Additionally, isolation barrier 30 may be used as a secondary liquid propellant for electrospray thruster 10 as shown by mixture 34, FIG. 2 to create thrust when operational.

In one example, ionic liquid 32 of propellant isolation barrier 30 is preferably a hydrophobic ionic liquid having a melting temperature greater than the melting temperature of primary propellant 14. In one example, ionic liquid 32 may be 1-ethyl-3-methylimidazolium hexafluorophosphate (EMI PF6). In other examples, ionic liquid 32 may be 1-methyl-3-(3,3, . . . -tridecafluoroctyl)imidazolium hexafluophosphate or tetrabutyl-ammonium bis(trifluoromethylsulfonyl)imide, or similar type ionic liquids using a PF6 ion having hydrophobicity.

Ionic liquid 32 is unique in that is it is relatively hydrophobic ionic liquid that can be stored for extended periods of time on the ground or on station, in solid form without propellant contamination or degradation.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A propellant isolation barrier comprising:
an ionic liquid configured to have a solid phase at temperatures less than a predetermined temperature and a liquid phase at temperatures greater than the predetermined temperature, the ionic liquid configured to:
create a propellant isolation barrier in the solid phase,
mix with a primary liquid propellant in the liquid phase, and
remain in the liquid phase and miscible with the primary liquid propellant at temperatures greater than and less than the predetermined temperature when mixed with the primary propellant.

2. The propellant isolation barrier of claim 1 in which the ionic liquid includes a hydrophobic ionic liquid having a melting temperature greater than the melting temperature of the primary propellant.

3. The propellant isolation barrier of claim 2 in which the ionic liquid includes one or more of: 1-ethyl-3-methylimidazolium hexafluorophosphate (EMI PF6), 1-methyl-3-(3,3, . . . -tridecafluoroctyl)imidazolium hexafluophosphate, and tetrabutyl-ammonium bis(trifluoromethylsulfonyl)imide.

4. The propellant isolation barrier of claim 1 in which the ionic liquid in the liquid phase is configured as a secondary liquid propellant.

5. The propellant isolation barrier of claim 1 in which the propellant isolation barrier is between the primary liquid propellant and the atmosphere.

6. The propellant isolation barrier of claim 5 in which the propellant isolation barrier prevents absorption of one or more of water vapor, atmospheric gases, and/or particles by the primary liquid propellant at atmospheric conditions.

7. The propellant isolation barrier of claim 5 in which the propellant isolation barrier prevents wetting of an emitter and a propellant delivery pathway of a wicking based feed subsystem of an electrospray thruster by the primary liquid propellant to ensure proper filling of a propellant storage vessel under the operation environment of the electrospray thruster system.

8. The propellant isolation barrier of claim 1 in which the propellant isolation barrier is valveless.

9. The propellant isolation barrier of claim 1 in which the primary liquid propellant includes an ionic liquid having electrical conductivity, viscosity and surface tension suitable for operation with an electrospray thruster.

10. The propellant isolation barrier of claim 9 in which the primary liquid propellant includes one or more of: 1-ethyl-3-methylimidazolium bis(trifluoromethylsulfonyl)imide (EMI-Im), 1-ethyl-3-methylimidazolium tetrafluoroborate, (EMI-BF4), 1-butyl-3-methylimidazolium hexafluorophosphate ([bmim][PF(6)]), and 1-ethyl-3-methylimidazolium thiocyanate.

11. A propellant isolation barrier for an electrospray device comprising:
an ionic liquid configured to have a solid phase at temperatures less than a predetermined temperature and a liquid phase at temperatures greater than the predetermined temperature, the ionic liquid configured to:
create a propellant isolation barrier in the solid phase,
mix with a primary liquid propellant in the liquid phase, and
remain in the liquid phase and miscible with the primary liquid propellant at temperatures greater than and less than the predetermined temperature when mixed with the primary propellant.

12. The propellant isolation barrier of claim 11 in which the ionic liquid includes a hydrophobic ionic liquid having a melting temperature greater than the melting temperature of the primary propellant.

13. The propellant isolation barrier of claim 12 in which the ionic liquid includes one or more of: 1-ethyl-3-methylimidazolium hexafluorophosphate (EMI PF6), 1-methyl-3-(3,3, . . . -tridecafluoroctyl)imidazolium hexafluophosphate, and tetrabutyl-ammonium bis(trifluoromethylsulfonyl)imide.

14. The propellant isolation barrier of claim 11 in which the ionic liquid in the liquid phase is configured as a secondary liquid propellant.

15. The propellant isolation barrier of claim 11 in which the propellant isolation barrier is between the primary liquid propellant and the atmosphere.

16. The propellant isolation barrier of claim 15 in which the propellant isolation barrier prevents absorption of one or more of water vapor, atmospheric gases, and/or particles by the primary liquid propellant at atmospheric conditions.

17. The propellant isolation barrier of claim 15 in which the propellant isolation barrier prevents wetting of an emitter and a propellant delivery pathway of a wicking based feed subsystem of an electrospray thruster by the primary liquid propellant to ensure proper filling of a propellant storage vessel under the operation environment of the electrospray thruster system.

18. The propellant isolation barrier of claim 10 in which the propellant isolation barrier is valveless.

19. The propellant isolation barrier of claim 12 in which the primary liquid propellant includes one or more of 1-ethyl-3-methylimidazolium bis(triflouromethylsulfonyl)amide, (EMI-Im), 1-ethyl-3-methylimidazolium tetrafluoroborate (EMI-BF4), 1-butyl-3-methylimidazolium hexafluorophosphate ([bmim][PF(6)]) and 1-ethyl-3-methylimidazolium thiocyanate.
